(19) United States
(12) Patent Application Publication
(10) Pub. No.: US 2011/0074675 A1
(43) Pub. Date: Mar. 31, 2011

(54) METHOD AND APPARATUS FOR INITIATING A FEATURE BASED AT LEAST IN PART ON THE TRACKED MOVEMENT

(75) Inventors: Ge Shiming, Beijing (CN); Fang Yikai, Beijing (CN); Xie Xiaohui, Beijing (CN); Li Jiangwei, Beijing (CN); Lei Xu, Beijing (CN); Kongqiao Wang, Beijing (CN)

(73) Assignee: NOKIA CORPORATION, Espoo (FI)

(21) Appl. No.: 12/569,764

(22) Filed: Sep. 29, 2009

(51) Int. Cl. G06F 3/033; H04N 5/225

(52) U.S. Cl. 345/158; 348/169; 348/E05.024

(57) ABSTRACT

In accordance with an example embodiment of the present invention, an apparatus comprising a camera configured to capture one or more media frames. Further, the apparatus comprises at least one processor and at least one memory including computer program code. The at least one memory and the computer program code is configured to, with the at least one processor, cause the apparatus to perform at least the following: filter the one or more media frames using one or more shaped filter banks; determine a gesture related to the one or more media frames; track movement of the gesture; and initiate a feature based at least in part on the tracked movement.

### TECHNICAL FIELD

The present application relates generally to initiating a feature based at least in part on the tracked movement.

### BACKGROUND

An electronic device may have a display for interaction of information. Further, there may be different types of information to display. As such, the electronic device displaying of different information.

### SUMMARY

Various aspects of examples of the invention are set out in the claims.

According to a first aspect of the present invention, an apparatus comprising a camera configured to capture one or more media frames. Further, the apparatus comprises at least one processor and at least one memory including computer program code. The at least one memory and the computer program code is configured to, with the at least one processor, cause the apparatus to perform at least the following: filter the one or more media frames using one or more shaped filter banks; determine a gesture related to the one or more media frames; track movement of the gesture; and initiate a feature based at least in part on the tracked movement.

According to a second aspect of the present invention, a method comprises capturing one or more media frames using a camera. Further, the method comprises filtering the one or more media frames using one or more shaped filter banks. Further still, the method comprises determining a gesture related to the one or more media frames. The method also comprises tracking movement of the gesture. Further, the method comprises initiating a feature on an electronic device based at least in part on the tracked movement.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting an electronic device operating in accordance with an example embodiment of the invention;

FIG. 2 is block diagram depicting an electronic device interacting with a display module in accordance with an example embodiment of the invention;

FIG. 3A is block diagram depicting a combined-shaped feature detection filter detection filter in accordance with an example embodiment of the invention;

FIG. 3B is a block diagram depicting feature detection filters operating in accordance with an example embodiment of the invention;

FIG. 4 is a block diagram depicting an example filter response in accordance with an example embodiment of the invention;

FIGS. 5A-5B are a block diagrams depicting fingertip candidates in accordance with an example embodiment of the invention;

FIG. 6 is a block diagram depicting various representations of fingertip candidates in accordance with an example embodiment of the invention;

FIG. 7A is a block diagram depicting tracking fingertip movement in accordance with an example embodiment;

FIG. 7B is a block diagram depicting fingertip movement in accordance with an example embodiment of the invention;

FIG. 8 is a block diagram depicting use of a projector and an associated finger motion trajectory in accordance with an example embodiment of the invention; and

FIG. 9 is a flow diagram illustrating an example method operating in accordance with an example embodiment of the invention.

### DETAILED DESCRIPTION OF THE DRAWINGS

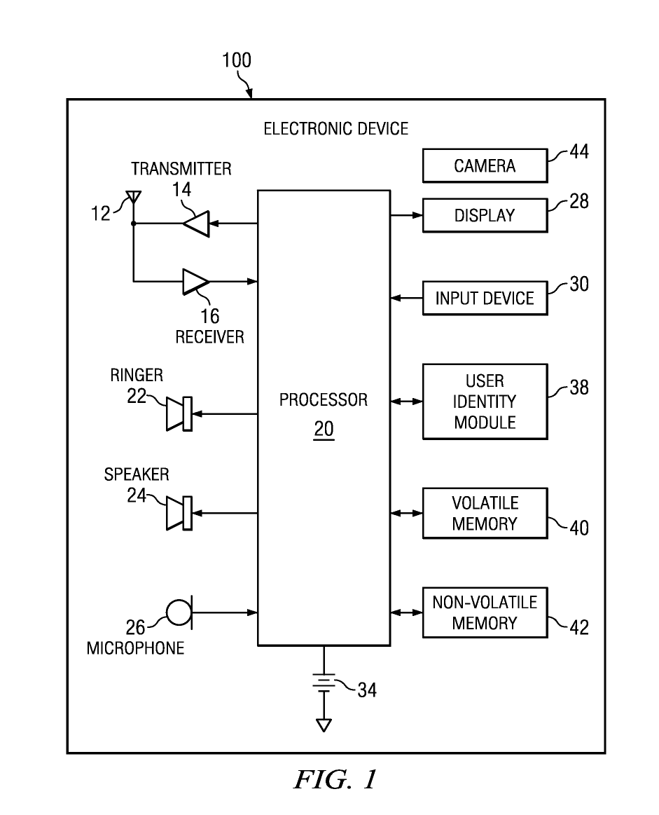

An example embodiment of the present invention and its potential advantages are understood by referring to FIGS. 1 through 9 of the drawings.

FIG. 1 is a block diagram depicting an electronic device 100 operating in accordance with an example embodiment of the invention. In an example embodiment, an electronic device 100 comprises at least one antenna 12 in communication with a transmitter 14, a receiver 16, and/or the like. The electronic device 100 may further comprise a processor 20 or other processing component. In an example embodiment, the electronic device 100 may comprises multiple processors, such as processor 20. The processor 20 may provide at least one signal to the transmitter 14 and may receive at least one signal from the receiver 16. In an embodiment, the electronic device 100 may also comprise a user interface comprising one or more input or output devices, such as a conventional earphone or speaker 24, a ringer 22, a microphone 26, a display 28, and/or the like. In an embodiment, an input device 30 comprises a mouse, a touch screen interface, a pointer, and/or the like. In an embodiment, the one or more output devices of the user interface may be coupled to the processor 20. In an example embodiment, the display 28 is a touch screen, liquid crystal display, and/or the like.

In an embodiment, the electronic device 100 may also comprise a battery 34, such as a vibrating battery pack, for powering various circuits to operate the electronic device 100. Further, the vibrating battery pack may also provide mechanical vibration as a detectable output. In an embodiment, the electronic device 100 may further comprise a user identity module (UIM) 38. In one embodiment, the UIM 38 may be a memory device comprising a processor. The UIM 38 may comprise, for example, a subscriber identity module (SIM), a universal integrated circuit card (UICC), a universal subscriber identity module (USIM), a removable user identity module (R-UIM), and/or the like. Further, the UIM 38 may store one or more information elements related to a subscriber, such as a mobile subscriber.

In an embodiment, the electronic device 100 may comprise memory. For example, the electronic device 100 may comprise volatile memory 40, such as random access memory (RAM). Volatile memory 40 may comprise a cache area for the temporary storage of data. Further, the electronic device 100 may also comprise non-volatile memory 42, which may be embedded and/or may be removable. The non-volatile memory 42 may also comprise an electrically erasable programmable read only memory (EEPROM), flash memory, and/or the like. In an alternative embodiment, the processor 20 may comprise memory. For example, the processor 20 may comprise volatile memory 40, non-volatile memory 42, and/or the like.

In an embodiment, the electronic device 100 may use memory to store any of a number of pieces of information and/or data to implement one or more features of the electronic device 100. Further, the memory may comprise an identifier, such as international mobile equipment identification (IMEI) code, capable of uniquely identifying the electronic device 100. The memory may store one or more instructions for determining cellular identification information based at least in part on the identifier. For example, the processor 20, using the stored instructions, may determine an identity, e.g., cell id identity or cell id information, of a communication with the electronic device 100.

In an embodiment, the processor 20 of the electronic device 100 may comprise circuitry for implementing audio feature, logic features, and/or the like. For example, the processor 20 may comprise a digital signal processor device, a microprocessor device, a digital to analog converter, other support circuits, and/or the like. In an embodiment, control and signal processing features of the processor 20 may be allocated between devices, such as the devices described above, according to their respective capabilities. Further, the processor 20 may also comprise an internal voice coder and/or an internal data modem. Further still, the processor 20 may comprise features to operate one or more software programs. For example, the processor 20 may be capable of operating a software program for connectivity, such as a conventional Internet browser. Further, the connectivity program may allow the electronic device 100 to transmit and receive Internet content, such as location-based content, other web page content, and/or the like. In an embodiment, the electronic device 100 may use a wireless application protocol (WAP), hypertext transfer protocol (HTTP), file transfer protocol (FTP) and/or the like to transmit and/or receive the Internet content.

In an embodiment, the electronic device 100 may be capable of operating in accordance with any of a number of a first generation communication protocol, a second generation communication protocol, a third generation communication protocol, a fourth generation communication protocol, and/or the like. For example, the electronic device 100 may be capable of operating in accordance with second generation (2G) communication protocols IS-136, time division multiple access (TDMA), global system for mobile communication (GSM), IS-95 code division multiple access (CDMA), and/or the like. Further, the electronic device 100 may be capable of operating in accordance with third-generation (3G) communication protocols, such as Universal Mobile Telecommunications System (UMTS), CDMA2000, wideband CDMA (WCDMA), time division-synchronous CDMA (TD-SCDMA), and/or the like. Further still, the electronic device 100 may also be capable of operating in accordance with 3.9 generation (3.9G) wireless communication protocols, such as Evolved Universal Terrestrial Radio Access Network (E-UTRAN) or the like, or wireless communication projects, such as long term evolution (LTE) or the like. Still further, the electronic device 100 may be capable of operating in accordance with fourth generation (4G) communication protocols.

In an alternative embodiment, the electronic device 100 may be capable of operating in accordance with a non-cellular communication mechanism. For example, the electronic device 100 may be capable of communication in a wireless local area network (WLAN), other communication networks, and/or the like. Further, the electronic device 100 may communicate in accordance with techniques, such as radio frequency (RF), infrared (IrDA), any of a number of WLAN techniques. For example, the electronic device 100 may communicate using one or more of the following WLAN techniques: IEEE 802.11, e.g., 802.11a, 802.11b, 802.11g, 802.11n, and/or the like. Further, the electronic device 100 may also communicate, via a world interoperability, to use a microwave access (WiMAX) technique, such as IEEE 802.16, and/or a wireless personal area network (WPAN) technique, such as IEEE 802.15, BlueTooth (BT), ultra wideband (UWB), and/or the like.

It should be understood that the communications protocols described above may employ the use of signals. In an example embodiment, the signals comprises signaling information in accordance with the air interface standard of the applicable cellular system, user speech, received data, user generated data, and/or the like. In an embodiment, the electronic device 100 may be capable of operating with one or more air interface standards, communication protocols, modulation types, access types, and/or the like. It should be further understood that the electronic device 100 is merely illustrative of one type of electronic device that would benefit from embodiments of the invention and, therefore, should not be taken to limit the scope of embodiments of the invention.

While embodiments of the electronic device 100 are illustrated and will be hereinafter described for purposes of example, other types of electronic devices, such as a portable digital assistant (PDA), a pager, a mobile television, a gaming device, a camera 44, such as a charge-coupled device, complementary metal oxide semiconductor, and/or the like, based at least in part on a camera for image recording, a video recorder, an audio player, a video player, a radio, a mobile telephone, a traditional computer, a portable computer device, a global positioning system (GPS) device, a GPS navigation device, a GPS system, a mobile computer, a browsing device, an electronic book reader, a combination thereof, and/or the like, may be used. While several embodiments of the invention may be performed or used by the electronic device 100, embodiments may also be employed by a server, a service, a combination thereof, and/or the like.

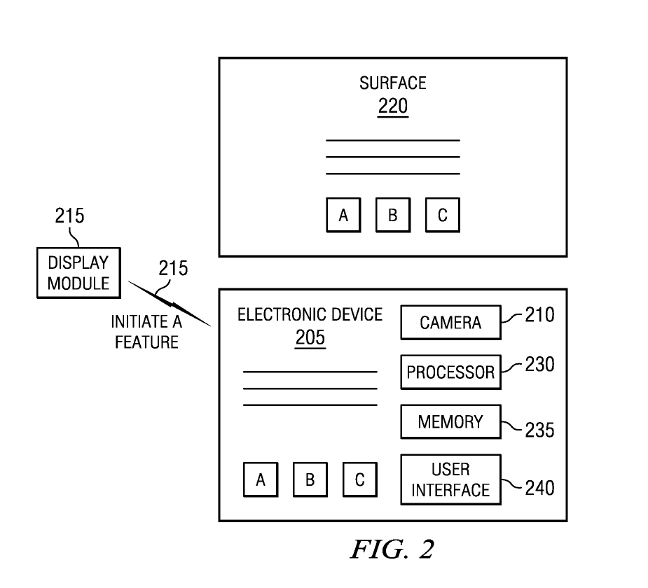

FIG. 2 is block diagram depicting an electronic device 205 interacting with a display module 215 in accordance with an example embodiment of the invention. In an example embodiment, the electronic device 205 is similar to electronic device 100 of FIG. 1. In an alternative embodiment, electronic device 205 is different than electronic device 100 of FIG. 1.

In an example embodiment, the electronic device comprises a camera 220, at least one processor 230, at least one memory 235, and/or the like. In an example embodiment, the camera 220 is configured to capture one or more media frames. For example, the camera 220 captures a gesture made by a user. In an example embodiment, the media is at least one of: video, image, a combination thereof, and/or the like. In an embodiment, the at least one memory 235 includes computer program code. Further, the at least one memory and the computer program code is configured to, with the at least one processor, cause the apparatus to perform at least the following: filter the one or more media frames using one or more shaped filter banks; determine a gesture related to the one or more media frames; track movement of the gesture; and initiate a feature based at least in part on the tracked movement. In an example embodiment, the at least one processor 230, causes the electronic device 205 to further perform at least the following: receive one or more inputs to interact with the electronic device 205. For example, the electronic device 205 receives user action, such as a finger movement.

In an example embodiment, the at least one processor 230 is similar to processor 20 of FIG. 1, camera 220 is similar to camera 44 of FIG. 1, and the at least one memory is similar to memory 40 of FIG. 1. In an alternative embodiment, the at least one processor 230 is different than processor 20 of FIG. 1, camera 220 is different than camera 44 of FIG. 1, and the at least one memory is different than memory 40 of FIG. 1.

In an example embodiment, the electronic device 205 is configured to be in communication with a display module 215. For example, the electronic device 205 communicating over a cable with a projector. In an embodiment, a user makes a gesture. In an example embodiment, the gesture is a fingertip touch. In such a case, example embodiments filter the one or more media frames using one or more shaped filter banks.

In an example embodiment, the at least one processor 230, cause the electronic device 205 to further perform at least the following: tracking fingertip parameters to track movement. Further, fingertip parameters are at least one of the following: position, scale, orientation, combination thereof, and/or the like. In an example embodiment, the at least one processor 230, causes the electronic device 205 to further perform at least the following: detect fingertip candidates using a shaped filter bank to track movement. In an example embodiment, the filter is a building basic shaped filter bank.

In an example embodiment, the electronic device 205 creates a real-time and reliable finger tracking technique with the capture of the finger movement using the camera 210. The technique may be used as the technology enabler for creating gesture controlled interaction solutions. The technique may be implemented by extracting image structural features based at least in part on shaped filter banks. In an embodiment, a fingertip is represented with the combination of an ellipse and a rectangle, so a fingertip region may be detected from the image based on a multi-parameter space (multi-direction and multi-scale). In such a case, a list of combined filter banks, which are combined with ellipse-shaped filter banks and rectangle-shaped filter banks, for example, are created to extracted all potential fingertips, e.g., various directions and various scales, from the image.

In an embodiment, an identification scheme may be imposed on the detected potential fingertip regions. With respect to fingertips, several discriminative measures are presented and integrated to reject probable false detections. Further, a smoothing scheme may be used to smooth the traces of the finger movement. If the detected fingertip in the current frame deviates too much from previous frames and next frames, the detected finger will be smoothed so that the curvature of the finger movement trace in the current frame is minimized It should be understood that example embodiments may be used for not only detecting and tracking single finger movement, but also multiple finger movements. Further, example embodiments may be extended to detect and track other objects, if the object can be described in a parameter space, e.g., selecting one or more suitable filter banks.

In an example embodiment, the one or more shaped filter banks is building basic shaped filer bank. In an embodiment, the building basic shaped filer bank is a basic two dimensional closed shape. In an embodiment, the closed shape is represented as a parametrical equation, such as E(x,y,σ₁,σ₂,θ)=0 in a multi-parameter space, where σ₁ and σ₂ are scale parameters in two orthometric directions, θ is orientation parameter, e.g., the angle of rotation. The denotation may be as follows: h(x,y,σ₁,σ₂,θ)=exp(−E(x,y,σ₁,σ₂,σ)).

In an embodiment, using the parametric representation of a shape, example embodiments determine a feature detection filter using the following formula H(x,y,σ₁,σ₂,θ)=N(σ₁,σ₂)(hₓₓ+h_{yy})=N(σ₁,σ₂)(Eₓ²+E_{y}²−Eₓₓ−E_{yy})h, where, N(σ₁,σ₂) is a normalized factor. In an embodiment, the shaped filter bank may be a family of feature detection filters with one or more scales and/or orientations, such as B={H(x,y,σ₁,σ₂,θ)|(σ₁,σ₂,θ)εΩ}, where Ω is a 3D parameter space.

In an example embodiment, the shape may be an ellipse and/or a rectangle. In such a case, the parametrical equation are, respectively, represented with:

$$E ( x , y , {σ}_{1} , {σ}_{2} , θ ) = \frac{{x}^{′2}}{2 {σ}_{1}^{2}} + \frac{{y}^{′2}}{2 {σ}_{2}^{2}} - 1 = 0 and E ( x , y , {σ}_{1} , {σ}_{2} , θ ) = max ( \frac{{x}^{′2}}{2 {σ}_{1}^{2}} , \frac{{y}^{′2}}{{σ}_{2}^{2}} ) - 1 = 0 ,$$

where max(•,•) is maximum operator, √2σ₁ and √2σ₂ are respectively major semi-axis and minor semi-axis, θ is the angle of rotation(orientation) respectively, and (x′,y′) are the rotated coordinates of (x,y), for example,

$$[ \begin{matrix}{x}^{′} \\ {y}^{′}\end{matrix} ] = [ \begin{matrix}cos θ & sin θ \\ - sin θ & cos θ\end{matrix} ] [ \begin{matrix}x \\ y\end{matrix} ] .$$

In an example embodiment, a corresponding discrete feature detection filters are, respectively, created with

$$H ( x , y , {σ}_{1} , {σ}_{2} , θ ) = \frac{( {x}^{2} + {y}^{2} - {σ}_{1}^{2} - {σ}_{2}^{2} )}{2 {πσ}_{1}^{2} {σ}_{2}^{2}} \frac{h ( x , y , \{ {σ}_{1} , {σ}_{2} \} , θ )}{{Σ}_{( x , y )} h ( x , y , \{ {σ}_{1} , {σ}_{2} \} , θ )} , \\ H ( x , y , {σ}_{1} , {σ}_{2} , θ ) = \frac{max ( {x}^{2} - 2 {σ}_{1}^{2} , {y}^{2} - 2 {σ}_{2}^{2} )}{2 {πσ}_{1}^{2} {σ}_{2}^{2}} \frac{h ( x , y , \{ {σ}_{1} , {σ}_{2} \} , θ )}{{Σ}_{( x , y )} h ( x , y , \{ {σ}_{1} , {σ}_{2} \} , θ )}$$

In an embodiment, the circle may be a special case of an ellipse and a square may be a special case for a rectangle, when σ₁=σ₂=σ. For a fingertip, the filter may be decomposed into a semi-circle and a semi-square. By combining the circle-shaped filter bank and square-shaped filter bank, for example, the combined filter bank to extract fingertips in a multi-parameter space may be obtained.

In an example embodiment, hybrid shaped filter banks may be employed. For example, by combining two of more basic shaped filter banks, the filter builds hybrid shaped filter banks to extract image features with a complex shape more accurately. Denote a set of basic filter banks as Λ={B₁,B₂, . . . }, where Bᵢ stands for i-th basic shaped filter bank. Take the combination of two basic shaped filter banks as example. Suppose the combination set is M={Mᵢⱼ|i=1,2, . . . ; j=1,2, . . . ; i≠j}, where Mᵢⱼ is the binary combined mask to combine Bᵢ and Bⱼ, then the feature detection filter is represented as H(x,y,σ₁,σ₂,θ)=Mᵢⱼ(x,y,σ₁,σ₂,θ)Hᵢ(x,y,σ₁,σ₂,θ)+λ(1−Mᵢⱼ (x,y,σ₁,σ₂,θ))Hⱼ(x,y,σ₁,σ₂,θ) where, λ is a tuning factor for smoothing the combined filter.

In an embodiment, the electronic device 205 determines a gesture related to the one or more media frames. For example, the electronic device 205 determines a finger movement gesture. In an example embodiment, the gesture relates to UP, DOWN, LEFT and RIGHT and may be used to move the focus from one item to another. [0126] An OPEN gesture may be used to open an item, while a CLOSE gesture may be used to close an open item. From a gesture order perspective, a CLOSE gesture typically follows an OPEN gesture. However, if there is one or more other gestures, for instance UP/DOWN/LEFT/RIGHT between, these gestures are disabled, and the system will accepts OPEN/CLOSE gestures. In an embodiment, a STOP gesture is used to make the focus stop on an item. A STOP gesture and a CLOSE gesture may be the same hand gesture. If the system detects an OPEN gesture, the gesture information, e.g., hand region size, hand gesture (OPEN), will be registered. Other gestures may also be captured.

In an embodiment, an indication of motions may refer to maneuvering in menus, toggling between items such as messages, images, contact details, web pages, files, etc, or scrolling through an item. Other hand gestures include moving hand gestures such as drawing of a tick in the air with an index finger for indicating a selection, drawing a cross in the air with the index finger for indicating deletion of an active object such as a message, image, highlighted region or the like. The electronic device 205 may be distributed to the end user comprising a set of predetermined hand gestures. Further, the user may also define personal hand gestures or configure the mapping between hand gestures and the associated actions according to needs and personal choice.

In an embodiment, the electronic device 205 tracks movement of the gesture. In an example embodiment, the electronic device 205 initiates a feature 225 based at least in part on the tracked movement. For example, the electronic device 205 initiates a display change on a surface 220 based at least in part by initiating a feature 225, namely different display, on the display module 215. It should be understood that example embodiments may be performed generally by the electronic device 205 and/or using components, such as the at least one processor 230, the at least one memory 235, a camera 210, and/or the like.

In an example embodiment, the at least one processor 230, causes the electronic device 205 to further perform at least the following: control a map navigator, a game, application, and/or the like. In an example embodiment, the at least one processor 230, causes the electronic device 205 to further perform at least the following: interact with a user interface 240. For example, a user performs a finger movement to control a game using the user interface 240.

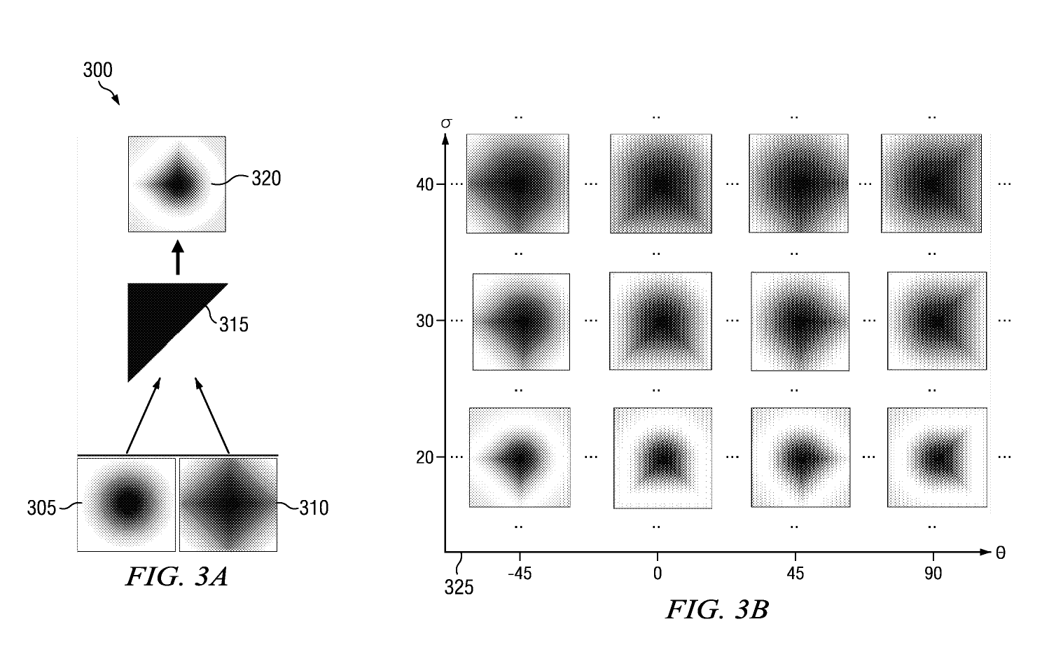

FIG. 3A is block diagram depicting a combined-shaped feature detection filter 300 in accordance with an example embodiment of the invention. The ellipse-shaped feature detection filter 305 and a rectangle-shaped feature detection filter 310 are combined via a binary combined mask 315 to form a combined feature detection filter 320. In such a case, the two scales are equal. The resulting combined filter may appear as a semi-circle connecting a semi-square inside the associated scale and orientation. Further, the filter may be truncated outside this scale.

FIG. 3B is a block diagram depicting feature detection filters 325 operating in accordance with an example embodiment of the invention. In particular, FIG. 3B depicts feature detection filters with various orientations and various scales in a hybrid shaped filter bank. A shaped filter bank may be viewed as a multi-template structure representation of an object with some shape. The measurement of filter banks may be viewed as a process of pattern matching, which matches filter kernels of various scales and various orientations to the given image pattern. The feature is localized at the local maximum of filter response over successive scales and orientations. Denote a point in the multi-parameter space as P=(x,y,σ₁,σ₂,θ), then the feature localization operation is represented by

$${P}^{*} = \{ P \} ⋂ arg {max}_{Q ∈ {N}_{P}} \{ \vert H ( Q ) ⊗ f ( x , y ) \vert \} ,$$

where, ∩ is intersection operator, Nₚ is the neighborhood of the point P in multi-parameter space, f is the feature likelihood map, H is the shaped filter bank (e.g., a hybrid shaped filter bank), and \textcircled{X} is convolution operation.

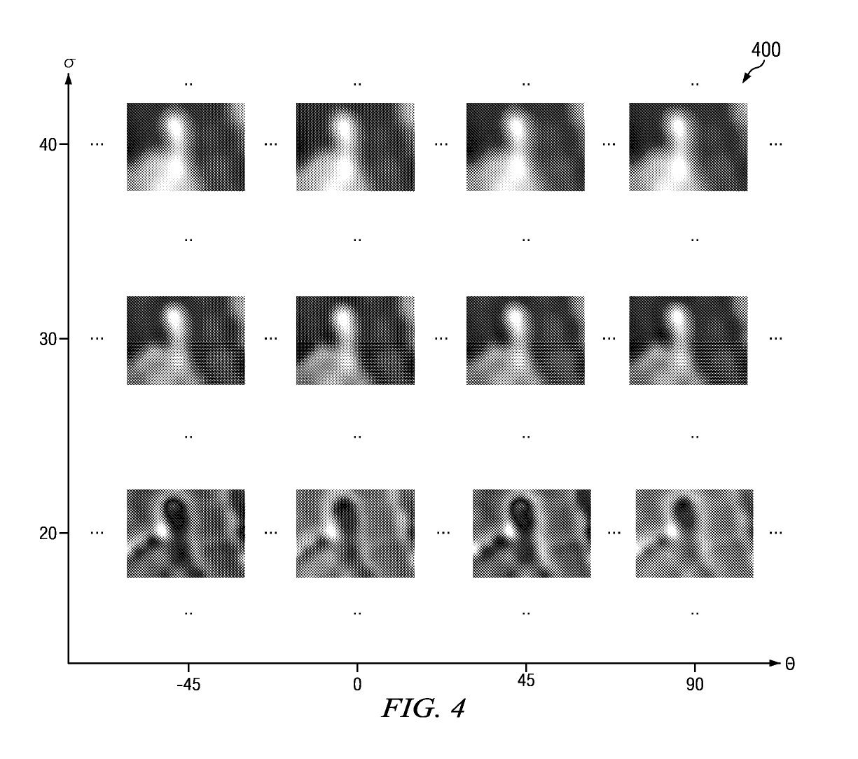

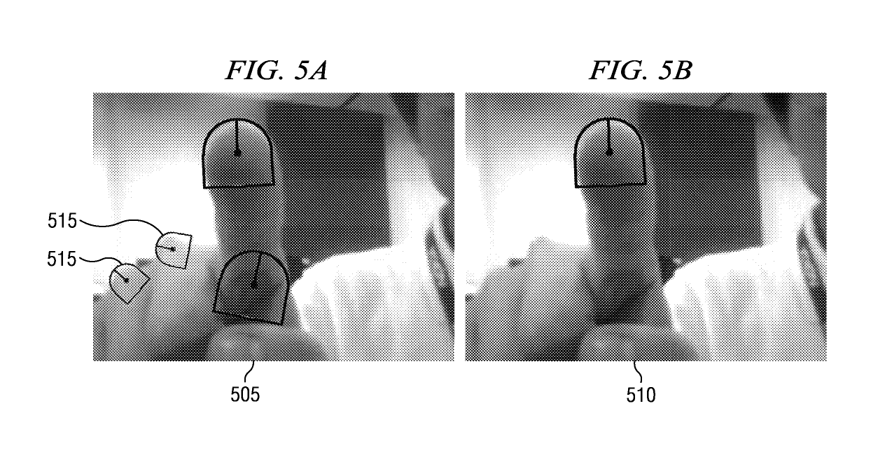

FIG. 4 is a block diagram depicting an example filter response 400 in accordance with an example embodiment of the invention. In particular, FIG. 4 depicts an example of filter responses with the hybrid shaped filter bank of FIG. 3B. The potential fingertip regions are emphasized, thus the associated filter responses appear more powerful. The feature localization may be formulated as a local searching problem in a multi-parameter space. Non-maximal suppression may be used to perform the local searching process. To accelerate the searching, example embodiments restrict the searching range according to some prior knowledge, e.g., the scale range, the sampled orientations, and/or the like. The filter response at a potential fingertip position p=(x,y) relates to a confidence level C(p). The potential fingertips are ranked according to a respective confidence levels. A potential fingertip whose confidence level is less than some thresh, such as, 0.8, may be rejected. As such, we can attain the fingertip candidates 505, as shown in FIG. 5a. The positions, scales and orientations are marked with small blue squares, green windows and purple lines, respectively. It should be understood that to make the algorithm real-time, a coarse segmentation is performed in input video frames to subtract background. The segmentation is based on color, image difference, connected component analysis, and/or the like. Also, a tracking is used by local detection and motion predication.

FIGS. 5A-5B are a block diagrams depicting fingertip 505, 510 candidates in accordance with an example embodiment of the invention. In an embodiment, the fingertip candidates 505, 510 are obtained by example embodiments and may include some false detections when there is a fingertip-like features/objects in image. In particular, FIG. 5A depicts some joints 515 are detected as fingertips. To make the extracted features effective in some high-level tasks, such as gesture interactions, an identification scheme is employed to reject the probable false detections. In an example embodiment, the identification scheme utilizes a set of measures to estimate the probability of each fingertip. Each measure gives a score for each detected fingertip candidate and the scores are normalized. The total score of i-th detected fingertip candidate Tᵢ is represented as V(Tᵢ)=ΣₖwₖVₖ(Tᵢ)/Σₖwₖ, where Vₖ represents the score with k-th measure and wₖ is its weight. A fingertip candidate will be rejected when its total score is below a pre-defined thresh (e.g. 0.5). FIG. 5B shows the fingertip candidate 510 after fingertip identification.

It should be understood that a normalized score can be viewed as a probability estimate of a fingertip. With respect to fingertip candidates 505, 510, example embodiments present several reliable and discriminative measures computed from segmentation binary masks, e.g., 1 for foreground and 0 for background. Geometric characteristic of fingertip are effective. The presented measures with respect to fingertips are as follows:

In an embodiment, Valid V₁ ratio constraints that the surrounding region of a detected position are enough large to be a fingertip. For a fingertip candidate T, its ratio of skin-color pixels in a sub-window w (including fingertip region T and its surrounding region and their relative size 605 is 2, is R(T)=Σ_{pεW}S(p)/|W|, where |*I is the number of pixels in region*. Then, the valid ratio is defined as

$${V}_{1} ( {T}_{i} ) = R ( {T}_{i} ) / {max}_{j} \{ R ( {T}_{j} ) \}$$

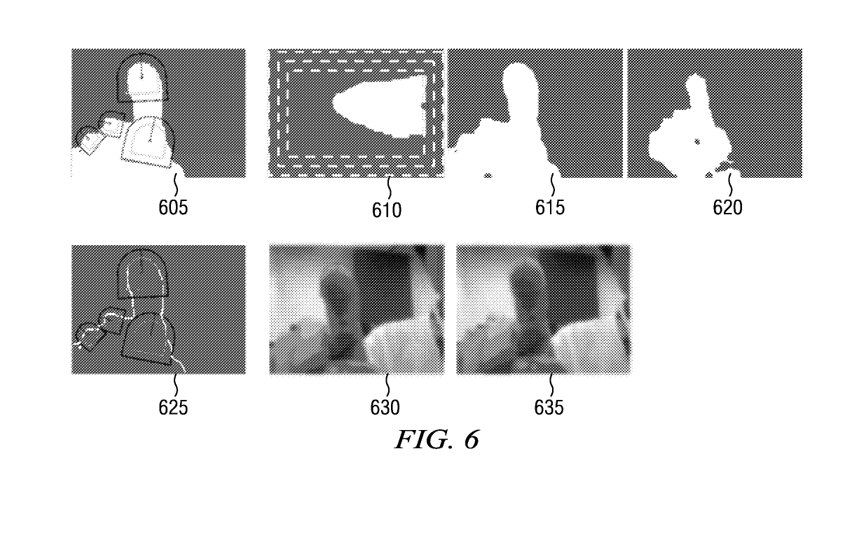

FIG. 6 is a block diagram depicting various representations of fingertip candidates in accordance with an example embodiment of the invention. In an embodiment, a camera detects a finger from an image boundary, where the fingertip is in the innermost point in the view. An electronic device, such as electronic device 205 of FIG. 2, determines a landmark point D in the image boundary of, for example, a searching rectangle, e.g., color dotted rectangles 610, which initializes with image boundary and literately shrink inwards with a d, e.g., 10 pixels, until the landmark point is found or the maximal iteration reaches. In an embodiment, the landmark point is defined as the center of longest continuous foreground pixels along the boundary of searching rectangle. Further, in an embodiment, the landmark point is in finger, palm, wrist, and/or the like in terms of a hand's placement, e.g., three examples 610, 615, and 620, respectively. An inner degree V₂ of a fingertip candidate is defined as the normalized distance from the landmark point D:

$${V}_{2} ( {T}_{i} ) = dist ( D , {T}_{i} ) / {max}_{j} \{ dist ( D , {T}_{j} ) \}$$

In an embodiment, segmentation binary masks, are obtained from the hand contour 625. For a fingertip candidate T, firstly the curvature salience V₃ of each contour point in its sub-window w is computed, then we sum up the first n (e.g., n=3) largest curvatures and get a total curvature value curv(T). The curvature salience of a fingertip candidate is its normalized total curvature value:

$${V}_{3} ( {T}_{i} ) = curv ( {T}_{i} ) {max}_{j} \{ curv ( {T}_{j} ) \}$$

In an embodiment, an Inter-frame V₄ similarity is presented to constraint the coherence between successive frames, and is defined as:

$${V}_{4} ( {T}_{i}^{( t )} ) = sim ( {T}_{i}^{( t - 1 )} , {T}_{i}^{( t )} ) / {max}_{j} \{ sim ( {T}_{j}^{( t - 1 )} , {T}_{j}^{( t )} ) \}$$

where, Tᵢ^{(t)} is i-th fingertip candidate 630 in current frame and Tᵢ^{(t-1) is its correspondence in previous frame 635. Similarity function integrates the parameter information (scale, orientation and position) and/or some other feature measures, such as sim(A,B)=exp(-[α(σ}_{A}−σ_{B})²+β(θ_{A}−θ_{B})²γ∥p_{A}−p_{B}∥²]), where α, β and γ are tuning factors.

For a fingertip, valid ration V₁ and curvature salience V₃ constraint its shape characteristics, inner degree V₂ constraints its position characteristic, and inter-frame similarity V₄ constraints its time variation characteristic. In the identification mechanism, it is useful to note that there are no restrictions to the measures. Thus, other measures, such as, measures based on edge, measures based at least in part on local feature description, and/or the like may be used in the identification.

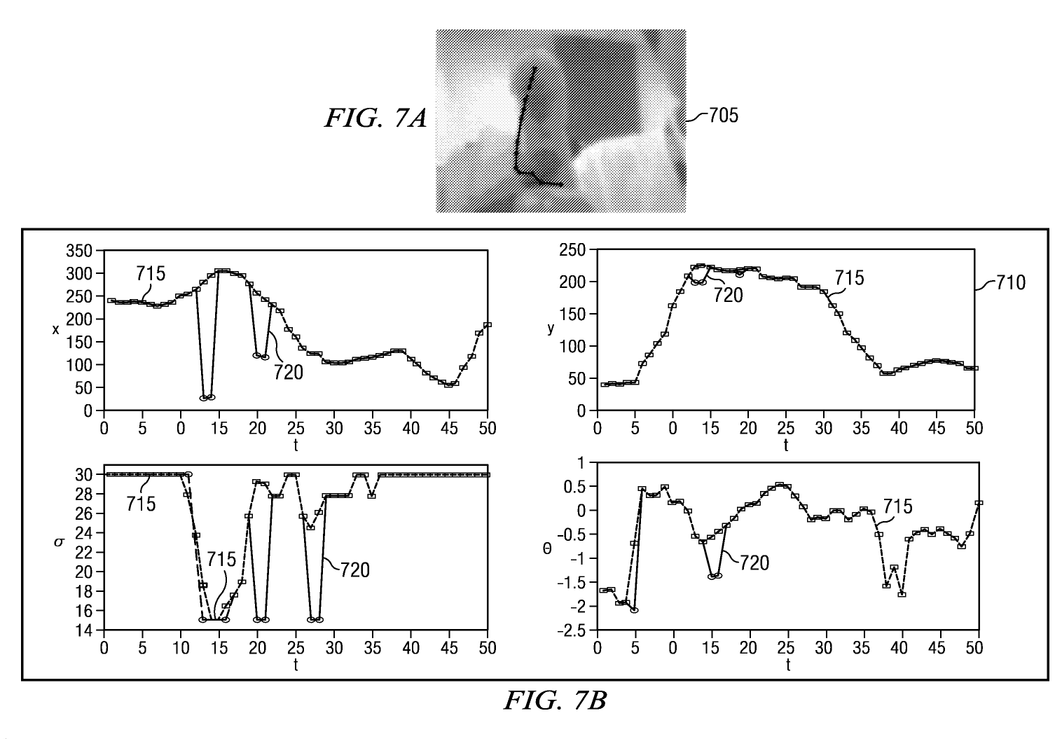

FIG. 7A is a block diagram 705 depicting tracking fingertip movement in accordance with an example embodiment. In particular, FIG. 7A depicts the patterns of fingertip movement traces recognized and/or interpreted as some predefined commands to, for example, enable the interactive applications, services, game, navigation, projector, and/or the like. To make the fingertip movement traces effective for gesture interactions, an example embodiment employs an optimization. In such a case, if the fingertip is missing detected or the detected fingertip in a current frame deviates too much from previous frame or frames and/or next frames, the fingertip location may be interpolated and/or smoothed. As a result, the total curvature of the fingertip movement traces is minimized.

FIG. 7B is a block diagram depicting fingertip movement in accordance with an example embodiment of the invention. In particular, FIG. 7B depicts fingertip movement traces before represented via non-smoothing lines 720 and smoothing lines 715 prior to and after smoothing, where The traces include several motion trajectories mirroring the variations in position, such as x and y directions, scale, orientation, and/or the like

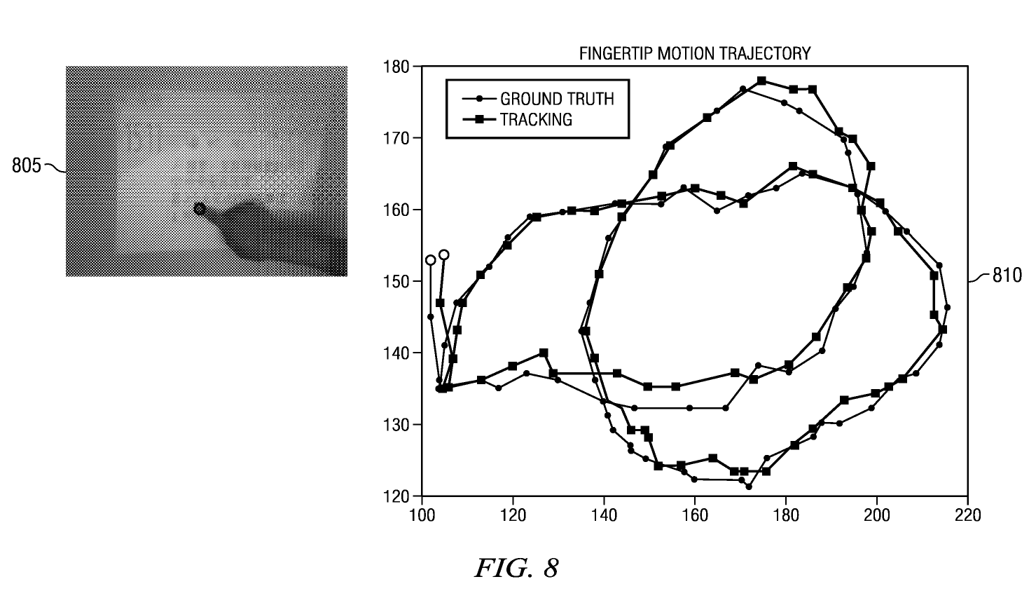

FIG. 8 is a block diagram depicting use of a projector and an associated finger motion trajectory in accordance with an example embodiment of the invention. In an example embodiment, a projector and a camera interacts on the camera-projected user interface by way of gestures and natural behaviors. To meet the interaction requirements, example embodiments employ a camera-projector interaction system with an electronic device and/or a pocket projector 805. In an embodiment, the pocket projector 805 emits scene of the mobile phone display onto a smooth surface and forms a simple and touchable interface, which allows interactions with the movement of a finger on the projected surface. An example finger motion trajectory 810 depicts the finger movement.

Referring back now to the camera, the camera may be equipped on the electronic device and may capture the movement of the finger. Our vision-based finger tracking system examines the video stream and tracks the position of the user's fingertip on the projected surface. The position of the fingertip is then mapped accordingly to the electronic device display, and may be used, for example, to control the devices. The tracking technology is the core technology enabler for a series of future applications, such as “Touch on Wall.” As such, the usability of finger tracking is useful to make this camera-projector interaction system practice.

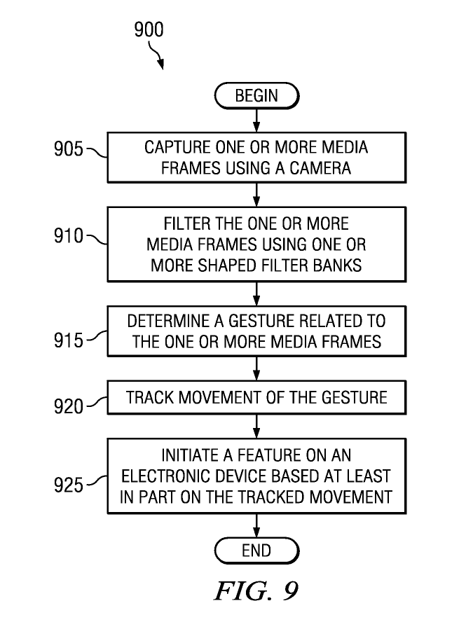

FIG. 9 is a flow diagram illustrating an example method 900 operating in accordance with an example embodiment of the invention. Example method 900 may be performed by an electronic device, such as electronic device 205 of FIG. 2.

At 905, one or more media frames are captured using a camera. In an example embodiment, the camera, such as camera 220 of FIG. 2, is configured to capture one or more media frames. For example, the camera captures a gesture made by a user.

At 910, the one or more media frames using one or more shaped filter banks are filtered. In an example embodiment, at least one memory and a computer program code is configured to, with at least one processor, cause an electronic device, such as electronic device 205 of FIG. 2, to perform at least the following: filter the one or more media frames using one or more shaped filter banks. For example, the gesture and/or finger of the user is filtered using a rectangle filter.

At 915, a gesture related to the one or more media frames is determined. In an example embodiment, the at least one memory and a computer program code is configured to, with at least one processor, cause the electronic device to perform at least the following: determine the gesture related to the one or more media frames. For example, the gesture is determined to be a finger press.

At 920, the movement of the gesture is tracked. In an example embodiment, the at least one memory and a computer program code is configured to, with at least one processor, cause the electronic device to perform at least the following: track movement of the gesture. For example, the electronic device uses the camera to track the movement of the user's finger.

At 925, a feature on an electronic device is activated. In an example embodiment, the at least one memory and a computer program code is configured to, with at least one processor, cause the electronic device to perform at least the following: initiate a feature based at least in part on the tracked movement. For example, the electronic device controls a navigation program based at least in part on the finger movement. The example method 900 ends.

Without in any way limiting the scope, interpretation, or application of the claims appearing below, a technical effect of one or more of the example embodiments disclosed herein is builds hybrid shaped filter banks to extract image features with a complex shape more accurately. Another technical effect of one or more of the example embodiments disclosed herein is the shaped filter bank focuses on locating the image features with a specific shape. Another technical effect of one or more of the example embodiments disclosed herein is the identification scheme is scalable. Another technical effect of one or more of the example embodiments disclosed herein is the extracted fingertips comprises rich context information, such as position, scale, orientation, and/or the like and the fingertip movement traces may be recognized and then utilized in high-level processing tasks, such as finger gesture interactions.

Embodiments of the present invention may be implemented in software, hardware, application logic or a combination of software, hardware and application logic. The software, application logic and/or hardware may reside on an electronic device, a computer, or a camera. If desired, part of the software, application logic and/or hardware may reside on an electronic device, part of the software, application logic and/or hardware may reside on a computer, and part of the software, application logic and/or hardware may reside on a camera. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a camera configured to capture one or more media frames;
at least one processor; and
at least one memory including computer program code
the at least one memory and the computer program code configured to, with the at least one processor, cause the apparatus to perform at least the following:
filter the one or more media frames using one or more shaped filter banks;
determine a gesture related to the one or more media frames;
track movement of the gesture; and
initiate a feature based at least in part on the tracked movement.

2. The apparatus of claim 1 wherein the media is at least one of: video, image, and a combination thereof.

3. The apparatus of claim 1 wherein the at least one processor, cause the apparatus to further perform at least the following: control a map navigator, a game, and application.

4. The apparatus of claim 1 wherein the at least one processor, cause the apparatus to further perform at least the following: interact with a user interface.

5. The apparatus of claim 1 wherein the at least one processor, cause the apparatus to further perform at least the following: receive one or more inputs to interact with the apparatus.

6. The apparatus of claim 1 wherein the filter is a building basic shaped filter bank.

7. The apparatus of claim 1 wherein the gesture is a fingertip touch.

8. The apparatus of claim 1 wherein the at least one processor, cause the apparatus to further perform at least the following: detect fingertip candidates using a shaped filter bank to track movement.

9. The apparatus of claim 1 wherein the at least one processor, cause the apparatus to further perform at least the following: tracking fingertip parameters to track movement.

10. The apparatus of claim 9 wherein the fingertip parameters is at least one of the following: position, scale, orientation, and a combination thereof.

11. A method, comprising:
capturing one or more media frames using a camera;
filtering the one or more media frames using one or more shaped filter banks;
determining a gesture related to the one or more media frames;
tracking movement of the gesture; and
initiating a feature on an electronic device based at least in part on the tracked movement.

12. The method of claim 11 wherein the media is at least one of: video, image, and a combination thereof.

13. The method of claim 11 wherein the feature is at least one of a map navigator, a game, and an application.

14. The method of claim 11 further comprising interacting with a user interface.

15. The method of claim 11 further comprising receiving one or more inputs to interact with the apparatus.

16. The method of claim 11 wherein filtering uses a building basic shaped filter bank.

17. The method of claim 11 further comprising detecting fingertip candidates using a shaped filter bank for tracking movement.

18. The method of claim 11 further comprising tracking fingertip parameters for tracking movement.

19. The method of claim 18 wherein the fingertip parameters is at least one of the following: position, scale, orientation, and a combination thereof.

20. A computer program product comprising a computer-readable medium bearing computer program code embodied therein for use with a computer, the computer program code comprising:
code for capturing one or more media frames using a camera;
code for filtering the one or more media frames using one or more shaped filter banks;
code for determining a gesture related to the one or more media frames;
code for tracking movement of the gesture; and
code for initiating a feature on an electronic device based at least in part on the tracked movement.
